(19) United States
(12) Patent Application Publication
(10) Pub. No.: US 2004/0080127 A1
(43) Pub. Date: Apr. 29, 2004

(54) Construction for connecting a snow slider to a sled runner

(76) Inventor: Derrick W. Charbonnet, Arlington, TX (US)

Correspondence Address: Charles W. McHugh, 1010 Milby Road, Arlington, TX, 76013, US

(21) Appl. No.: 10/377,190

(22) Filed: Jun. 24, 2003

Related U.S. Application Data
(60) Provisional application No. 60/361,193, filed on Feb. 28, 2002.

(51) Int. Cl. B62B 13/02

(52) U.S. Cl. 280/28

(57) ABSTRACT

Rigidly attached to the bottom of a dogsled runner is an elongated housing. The housing has a cavity that runs internally for substantially the full length of the housing. A passage extends downwardly from the cavity, and is bounded on its bottom by a mouth and bounded on its top by two spaced-apart and parallel ledges. The passage has two smooth and slanted sidewalls that extend upwardly from the mouth to the two ledges. The separation distance between the two ledges is less than the width of the mouth.

An elongated slider of low-friction material is selectively connected to each housing. Extending upwardly from each slider are two elongated and generally parallel members that have tops that pass through the passage and into the housing's cavity. The tops have outwardly extending lips that extend over and bear against the top surfaces of the housing's two ledges.

### CROSS-REFERENCE TO A RELATED APPLICATION

This application contains information that was originally disclosed in Provisional Patent Application 60/361,193 by the same inventor, dated Feb. 28, 2002.

### FIELD OF THE INVENTION

This invention relates generally to low-friction sliders for attachment to runners on sleds that are routinely pulled by dogs over snow and ice; more specifically, it relates to a construction that improves the manner of installing such sliders.

### BACKGROUND OF THE INVENTION

It is well known to transport people and things over snow and ice by pulling them in a sled. In North America, relatively heavy loads are often pulled by large draft animals such as horses; smaller loads are usually pulled by very hardy dogs that usually are specially bred for this purpose. A dogsled normally consists of a generally horizontal platform that is supported above the ground by a framework that normally includes a pair of generally vertical frames that are rigidly connected at their tops to the platform, and bounded at their bottoms by narrow elongated runners. When the demands on the runners are not great, the bottom surfaces of the runners may be the actual snow-contacting or ice-contacting surfaces. But when speed is important, it is customary to provide a low-friction material on the bottom of each runner—to foster an easier and more rapid passage of the sled over the snow and/or ice. This low-friction material may be in the form of a liquid (applied as a spray) or a wax, or it may be a solid material in the form of a thin, narrow sheet; such a narrow sheet is commonly called a slider.

One very simplistic design for providing a low-friction slider on each runner is shown in U.S. Pat. No. 3,120,963 to Seckel entitled “Shield Member For Sled-Like Vehicles.” The Seckel shield (which could be better described as almost a sheath for a sled runner) is shown as an elongated body having a channel-shaped cross-section that can wrap around and envelop a metal runner after the somewhat resilient body has been temporarily distended and then allowed to “snap” in place around the runner. The preferred material for the shield was described by Seckel in 1962 as one of the polyolefines having a density from 0.935 to 0.970 g/cc and a melt index of 0.1 to 10. To further reduce the coefficient of friction of the plastic shield, it was said that a “slip agent” may be incorporated into the plastic shield. Today we might simply describe the Seckel shield as being in that class of materials that we call a low-friction plastic. But according to Seckel he also relies on friction between his plastic shield and the steel runner to help keep the shield in place over the runner. If the goal of his shield is to reduce friction between the runner and snow/ice, it is not clear how the homogeneous shield can also exhibit high friction to hold the shield securely to the runner.

Of course, Seckel also gets some benefit from the geometry of his shield, wherein the two upper lips of his channel-shaped shield extend over the top of his steel runner. But it must also be recognized that an effective locking system that is clean and dry will not necessarily remain as effective when ice and snow begin to build up on top of the steel runner. That is, accumulated ice on top of the runner can effectively form a wedge that tends to pry apart the two Seckel lips, thereby reducing the security of the mechanical “lock” that might have been effective in its dry condition.

A later construction for a slider is shown in the 1986 patent (U.S. Pat. No. 4,591,174) to White entitled “Snow Slider Replacement System And Method”. White uses an internal, dovetail latching arrangement that prusumably would solve the “external lips” latching problem described above with regard to Seckel. But White avoids the Seckel problem while introducing a new one. Specifically, White can replace one slider only by sliding it longitudinally (to the rear) for the full length of a runner until the slider falls free. To substitute a second slider onto a runner, the two must be longitudinally aligned, with the rear of the runner being placed placed essentially end-to-end with the forward end of the second slider. By maneuvering, twisting and/or wiggling the two pieces, the dovetailed slider and the complementary recess on the runner can be engaged for a short distance; then the slider is pushed forward (longitudinally along the runner) for its full length of several feet, until it comes to rest in the runner's recess. As might be expected, any dirt, snow or ice that is present within the close-fitting recess can make inserting a new slider very difficult. And during a race (such as the Iditarod in Alaska), delays in substituting one slider for another can create a significant factor in elapsed time. Accordingly, it is an object of this invention to provide an improved latching arrangement for connecting a slider to the runner of a sled—to avoid the handicap of a “feed-from-the-end” construction of White.

Another object is to provide a “snap-lock” fastening system for a slider element to be connected to a sled, wherein the locking connection is protected inside the sled's runner (where it is not vulnerable to the build-up of accumulated snow and ice on the runner).

### BRIEF DESCRIPTIONS OF THE INVENTION

This invention is concerned with a construction for attachment to the bottom of a runner on a dogsled, said construction being adapted to foster reduced drag as the dogsled is pulled over ice and snow. A conventional runner has a top, a bottom and a length, and the runner's top is rigidly attached to the dogsled's platform. Rigidly attached to the bottom of the runner is an elongated housing, said housing having a length substantially the same as that of the dogsled's runner. The housing has a longitudinal cavity that runs internally for substantially the full length of the housing. There is a downwardly opening passage from the cavity, said passage being bounded on its bottom by a mouth and bounded on its top by two spaced-apart and parallel ledges. The two ledges form part of the cavity's lower boundary, and the passage has two smooth and slanted sidewalls that extend upwardly from the mouth to the two ledges. The separation distance between the two ledges is less than the width of the mouth, so that the transverse shape of the passage is essentially that of an isosceles trapezoid (wherein the top is parallel to the bottom, and the top being shorter than the bottom).

There is also provided an elongated slider of low-friction material that is adapted for selective connection to the bottom of each of the housings. Each slider has a top and a bottom, and each slider's bottom is smooth and adapted for sliding movement over snow and ice.

Upwardly extending from the top of each of the two sliders are two elongated and generally parallel members, said members extending upwardly on either side of a central plane that passes longitudinally through the slider. The elongated members have tops and a height that permits their tops to pass through the mouth of the housing's passage and into the housing's cavity. The two elongated members have at their tops outwardly oriented lips, i.e., lips that extend away from (and essentially perpendicularly to) the central plane. The lips are sized and shaped to extend over and bear against at least a part of the top surfaces of the housing's two ledges when the elongated members are in their rest configuration. The material from which the elongated members are made is sufficiently resilient as to permit the elongated members to be temporarily deflected inwardly (toward the central plane) in order to pass through the passage. The material of the elongated members also has a memory that causes the elongated members to immediately return to their rest configuration after the two lips have passed through the passage and risen to just above the two ledges. A slider may thus be connected to a housing by first positioning an upright slider immediately below the mouth of the housing's passage. The slider is then pushed transversely toward the housing until the two elongated members are deflected inwardly—by being pushed against the passage's fixed sidewalls. Pushing is continued until the lips pass just beyond the two ledges in the cavity, whereupon whereupon the resilience of the two elongated members causes them (and their associated lips) to spring outwardly—where the lips come to rest over an upper part of the ledges. A slider is thereby secured to the bottom of the runner, with what may be aptly called a snap-lock action.

### BRIEF DESCRIPTION OF THE FIGURES OF THE DRAWING

FIG. 1 is a transverse cross-sectional view of a dogsled runner of the prior art, wherein a slider is installed by pushing the slider longitudinally with respect to the metallic structure of the runner;

FIG. 2 is a transverse cross-sectional view of a slider of the prior art that is compatible with the runner shown in FIG. 1;

FIG. 3 is a transverse cross-sectional view of a runner (or rail) in accordance with this invention;

FIG. 3a is a pictorial view of the runner of FIG. 3, artificially divided into its two major elements, i.e., its upper and lower elements;

FIG. 4 is another view of the runner of this invention, looking along the longitudinal axis of the housing (and its internal cavity);

FIG. 5 is a transverse cross-sectional view of a slider and the elongated members that make possible the selective attachment of the slider to a housing;

FIG. 6 is an enlarged view of the top of an elongated member, showing the general triangular shape of the top;

FIG. 7 is an elevational view of an elongated member—showing the transverse cuts that divide the member into discrete segments; and

FIGS. 8a, 8b and 8c show progressive engagement of a slider with a housing, as the slider is aligned with the immediately adjacent housing and then pushed toward the housing.

### DETAINEL DESCRIPTION OF A PREFERRED EMBODIMENT OF THE INVENTION

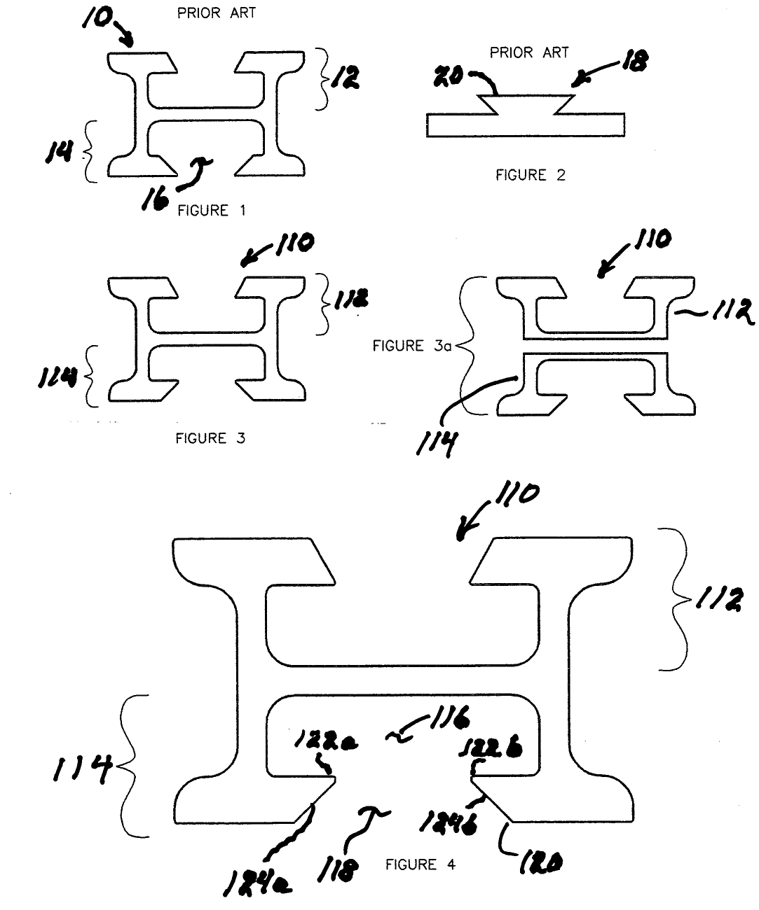

Referring initially to FIG. 1, a dogsled runner 10 (also called a rail) in accordance with the prior art ia shown in cross-section, i.e., perpendicularly to the rail's longitudinal axis. The upper part of the rail 10 is identified by the reference numeral 12, and it is configured to be attached to the runner of a sled in a known manner. The lower part 14 is configured in accordance with the teachings of White in U.S. Pat. No. 4,591,174. That is, the lower part has a shape that includes a recess 16 with slanted surfaces that together form what is commonly called a “dovetail” shape. A companion piece, i.e., a slider 18 (an example of which is shown in FIG. 2) is shaped so that an upper part 20 will fit snugly in the recess 16 and be held there until it is deliberately removed. According to the White patent, removal of the slider 18 can be accomplished by pulling transversely on the slider, i.e., pulling in a direction that is downward and perpendicular to the longitudinal axis of the rail. But, of course, the rigidity of the slider material will have a significant impact on exactly how easy this step might be. And even if the slider can be slightly deformed and transversely removed, its natural shape may be sufficiently damaged to the extent that it cannot be reused. But one thing is not controverted, either in the White patent or in known practice, installation of a replacement slider is always accomplished by starting engagement of such a slider at the rear end of the rail and pulling (or pushing) the slider longitudinally forward along the rail.

Turning next to FIG. 3, a rail 110 in accordance with this invention has an upper portion 112 and a lower portion 114. To foster compatibility with existing sleds, the upper portion 112 is given a shape and size so that it will be interchangeable with rails of the White design (which are frequently used on dogsleds). The lower portion 114 will perhaps be best understood by describing it as a housing; and although not mandatory, it is probably more efficient (from a manufacturing point of view) to extrude the upper portion 112 and the housing 114 as a compound element of metal or the like. To foster a better appreciation for the two parts of the rail, FIG. 3a shows these two parts separated, although they are more likely to be seen in the real world as a unit.

Referring next to FIG. 4, the housing 114 has an elongated recess or cavity 116 that extends centrally of the housing for substantially its full length. The cavity 116 has a downwardly opening passage 118 that is bounded on its bottom by a mouth 120 and bounded on its top by two spaced-apart and parallel ledges 122a, 122b that form part of the cavity's lower boundary. The passage 118 has smooth and slanted sidewalls 124a, 124b that extend upwardly from the mouth 120 to the two ledges 122a, 122b, and the separation distance between the two ledges is less than the width of the mouth. As a result, a transverse cross-sectional view of the passage 118 will appear as an isosceles trapezoid, with the top and bottom being parallel and the top being shorter than the bottom.

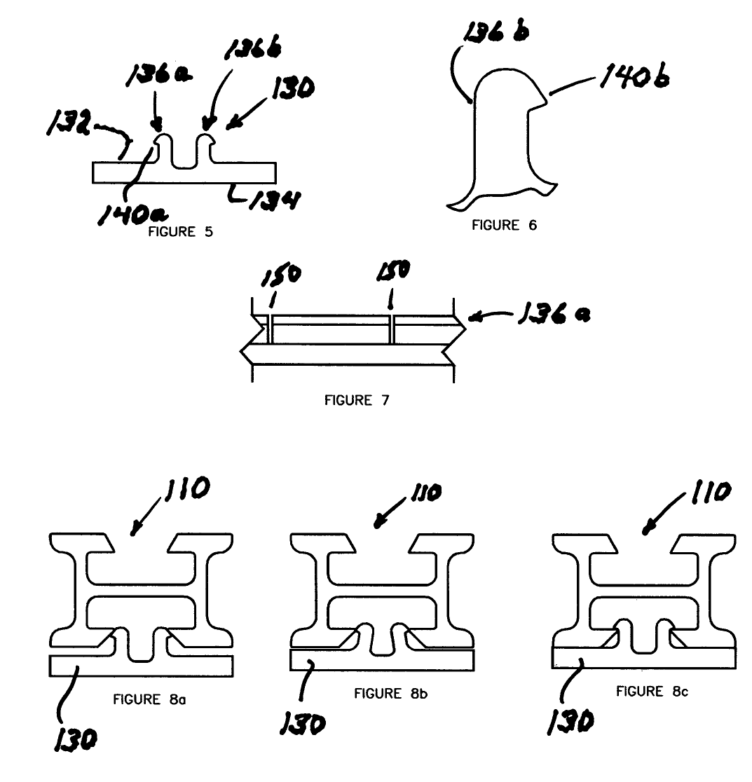

Referring next to FIG. 5, there is shown a transverse cross-sectional view of an elongated slider, said slider 130 being of low-friction material that is adapted for selective connection to the bottom of the housing. The slider 130 has a top 132 and a bottom 134, and the slider's bottom is smooth and adapted for sliding movement over snow and ice. A preferred material for the slider is an ultra-high molecular weight polyethylene having a molecular weight in excess of one million. In fact, a molecular weight on the order of 2 million is recommended by some “experts” in sled construction, and—when available—a molecular weight of 4 million is preferred.

Also shown in FIG. 5 are two elongated and generally parallel members 136a, 136b that are affixed to and extend upwardly from the top of the slider—on either side of a central plane 138 that passes longitudinally through the slider. The two elongated members 136a, 136b have tops that extend into free space in the manner of cantilevered members—when they are in their rest condition. The height of the elongated members 136a, 136b is such as to permit their tops to pass through the passage 118 and extend into the housing's cavity 116. The two elongated members have at their tops outwardly oriented lips 140a, 140b that are sized and shaped to extend over and be in a position to bear down against at least a part of the top surfaces of the housing's two ledges 122a, 122b when the elongated members are in their rest configuration. The amount of overlap of a lip 140a or 140b over an adjacent ledge is preferably at the rate of 0.0315 square inch per linear inch of an elongated member. As an example, an overlap of 0.315 square inches will exist for each ten inches of length of an elongated member.

The material from which the elongated members are made (polyethylene) and their shape make it possible to temporarily deflect the elongated members 136a, 136b inwardly (toward the central plane 138) in order to let them pass through the narrow passage 118. Examples of such materials can be found in the following US patents: U.S. Pat. No. 5,145,201 (1992) to Metheny entitled “Vehicular Snow Ski”; and U.S. Pat. No. 5,914,298 (1999) to Karydas entitled “Fluorinated Lubricants For Polyethylene Snow Sliders.” The material of the elongated members 136a, 136b has a memory that causes the elongated members to immediately return to their rest configuration after the two lips have passed through the passage and risen to just above the two ledges 122a, 122b. Hence, a slider 130 may be connected to a housing 114 by first positioning an upright slider 130 immediately below the mouth of the housing's passage 118, and then pushing the slider transversely—toward the housing.

To foster ease of installation of a fresh slider 130, the tops of the elongated members are provided with downwardly sloped outer sides, with the result that the tops may be described as having generally triangular cross-sections. (See FIG. 6.) The downwardly and outwardly sloping sides are oriented oppositely—and their orientation is established so they will be essentially congruent with the confronting sidewalls of the passage 118. In other words, the hypotenuse of the generally triangular shaped top will rub against the sidewalls of the passage 118 as the slider 130 is pushed transversely toward the housing 114 during connection of a slider to a runner 110.

If the geometry and the material of the elongated members 136a, 136b seemingly makes it too hard to manually push a given slider 130 into engagement with the housing 114, there can be provided a plurality of transverse cuts in the elongated members 136a, 136b. The cuts, represented by gaps 150 in FIG. 7, are spaced apart by a distance of at least one foot and preferably about two feet. These transverse cuts 150 function to divide the elongated members 136a, 136b into distinct and separate sections or units that be pushed—individually—into engagement with the housing 114. These short sections of the elongated elements provide more lateral flexibility, and they foster ease of engagement between a slider and a rail. But the discrete units will act collectively, of course, to hold the slider 130 in engagement with the housing 114 when all of the units have been pushed upwardly into the downwardly opening passage 118.

The tops of the elongated members will first make contact with the passage's slanted sidewalls, and continued pushing will eventually cause the elongated members to deflect inwardly. FIG. 8a shows the top of an elongated member as it makes initial contact with a sidewall of a downwardly opening passage. FIG. 8b shows the temporary deflection of the elongated member as the slider is pushed (transversely) toward the housing. And FIG. 8c shows the elongated member after it has returned to its “rest” condition in which its associated lip overhangs a part of the adjacent ledge in a cavity 116.

What is claimed is:

1. A construction for attachment to the bottom of a runner on a dogsled, said construction being adapted to foster reduced drag as the dogsled is pulled over ice and snow, and the runner having a top, a bottom and a length, and the runner's top being rigidly attached to the dogsled's platform, comprising the combination of:
a. an elongated housing having a length substantially the same as that of the dogsled's runner, and the housing being connected to the bottom of the runner, and the housing having a longitudinal cavity that runs internally for substantially the full length of the housing, and there being a downwardly opening passage from the cavity that is bounded on its bottom by a mouth and bounded on its top by two spaced-apart and parallel ledges that form part of the cavity's lower boundary, and the passage having smooth and slanted sidewalls that extend upwardly from the mouth to the two ledges, and the separation distance between the two ledges being less than the width of the mouth;
b. an elongated slider of low-friction material adapted for selective connection to the bottom of the housing, said slider having a top and a bottom, and said slider's bottom being smooth and adapted for sliding movement over snow and ice; and
c. two elongated and generally parallel members, said members extending upwardly from the top of the slider on either side of a central plane that passes longitudinally through the slider, and the elongated members having tops and a height that permits their tops to pass through the mouth of the passage and extend into the housing's cavity, and the two elongated members having at their tops outwardly oriented lips that are sized and shaped to extend over and bear against at least a part of the top surfaces of the housing's two ledges when the elongated members are in their rest configuration, and the material from which the elongated members are made being sufficiently resilient as to permit the elongated members to be temporarily deflected inwardly in order to pass through the passage, and the material of the elongated members having a memory that causes the elongated members to immediately return to their rest configuration after the two lips have passed through the passage and risen to just above the two ledges, whereby a slider may be connected to a housing by first positioning an upright slider immediately below the mouth of the housing's passage and then pushing the slider transversely toward the housing until the elongated members are deflected by the passage's sidewalls, and continuing said pushing until the lips pass just beyond the two ledges in the cavity.

2. The construction as claimed in claim 1 wherein the runner of the dogsled and the housing are integrally formed as a one-piece metal extrusion.

3. The construction as claimed in claim 1 wherein the slider is formed of an ultrahigh molecular weight material having a molecular weight in excess of one million.

4. The construction as claimed in claim 1 wherein the tops of the two lips have a transverse cross-sectional shape that is generally triangular, and the lips are oriented such that the hypotenuse of the generally triangular shape will rub against the sidewalls of the passage as the slider is pushed transversely toward the housing during connection of a slider to a runner.

5. The construction as claimed in claim 1 wherein there are a plurality of transverse cuts in the elongated members that are spaced apart by a distance of about two feet, whereby the transverse cuts function to segregate the elongated members into separate units that be pushed individually into engagement with the housing, and whereby the units act collectively to hold the slider in engagement with the housing when all of the units have been pushed into the downwardly opening passage.

6. The construction as claimed in claim 1 wherein there is an area of overlap between a lip and a ledge at the rate of 0.0315 square inch per linear inch of elongated member.

7. A method for attaching a slider to the bottom of a runner on a dogsled, said slider being adapted to foster reduced drag as the dogsled is pulled over ice and snow, and the runner having a top, a bottom and a length, and the runner's top being rigidly attached to the dogsled's platform, and the slider having a top and a bottom, comprising the steps of:
a. providing an elongated housing having a length substantially the same as that of the dogsled's runner, and rigidly connecting the housing to the bottom of the runner, and the housing having a longitudinal cavity that runs internally for substantially the full length of the housing, and there being a downwardly opening passage that is bounded on its bottom by a mouth and bounded on its top by two spaced-apart and parallel ledges that form part of the cavity's lower boundary, and the passage having smooth and slanted sidewalls that extend upwardly from the mouth to the two ledges, and the separation distance between the two ledges being less than the width of the mouth;
b. attaching to the top of the slider two elongated and generally parallel members, said members extending upwardly from the top of the slider on either side of a central plane that passes longitudinally through the slider, and the elongated members having a height that permits their tops to pass through the mouth of the passage and extend into the housing's cavity, and the two elongated members having at their tops outwardly oriented lips that are sized and shaped to extend over and bear against at least a part of the tops of the housing's two ledges when the elongated members are in their rest configuration, and the material from which the elongated members are made being sufficiently resilient as to permit the elongated members to be temporarily deflected inwardly in order to pass through the passage, and the material of the elongated members having a memory that causes the elongated members to immediately return to their rest configuration after the two lips have passed through the passage and risen just above the two ledges;
c. positioning the upright slider immediately below the mouth of the housing's passage; and
d. pushing the slider transversely toward the housing until the elongated members are respectively deflected by the passage's two sidewalls, and continuing to push said slider until the lips pass just beyond the two ledges in the cavity, such that the memory in the elongated members will cause the elongated members to return to their rest configuration and the slider will be securely held in juxtaposition with the runner.

8. The method as claimed in claim 7 and including the further step of providing a plurality of transverse cuts through the two elongated members so as to create segments of the elongated members that are at least one foot long, said transverse cuts being made before the slider is positioned below the mouth of the housing's passage, such that the elongated members can achieve full engagement with the housing by virtue of sequentially pushing adjacent segments of the elongated members transversely toward the housing, whereby full engagement of the slider with the housing is achieved one segment at a time.
